(19) United States
(12) Patent Application Publication
(10) Pub. No.: US 2025/0014378 A1
(43) Pub. Date: Jan. 9, 2025

(54) DOCUMENT PROCESSING SYSTEM THAT EXECUTES SPECIFIC PROCESS ON DOCUMENT, AND COMPUTER-READABLE, NON-TRANSITORY STORAGE MEDIUM STORING THEREIN DOCUMENT PROCESSING PROGRAM

(71) Applicant: KYOCERA Document Solutions Inc., Osaka (JP)

(72) Inventor: Daisuke YOSHIDA, Osaka (JP)

(73) Assignee: KYOCERA Document Solutions Inc., Osaka (JP)

(21) Appl. No.: 18/761,502

(22) Filed: Jul. 2, 2024

(30) Foreign Application Priority Data
Jul. 5, 2023 (JP) 2023-110432

(51) Int. Cl. G06V 30/41; G06F 16/16; G06V 30/10

(52) U.S. Cl. CPC G06V 30/41; G06F 16/164; G06V 30/10

(57) ABSTRACT

A document processing system includes a storage device, and a control device. The storage device contains a document processing program. The control device includes a processor, and executes, when the processor executes the document processing program, an operation including extracting, through OCR, a plurality of values from a document having a form of electronic data, containing the plurality of values with respect to a specific item, reproducing a same number of the documents as a number of pieces of the values extracted, and assigning a file name including the value, to each of the values, as the file name of each of the documents generated through the reproduction.

### INCORPORATION BY REFERENCE

This application claims priority to Japanese Patent Application No. 2023-110432filed on Jul. 5, 2023, the entire contents of which are incorporated by reference herein.

### BACKGROUND

The present disclosure relates to a document processing system that executes a specific process on a document, and to a document processing program.

A document processing system that divides image data read from a document including a plurality of pages, and stores the divided data, is known.

### SUMMARY

The disclosure proposes further improvement of the foregoing techniques.

In an aspect, the disclosure provides a document processing system including a storage device, and a control device. The storage device contains a document processing program. The control device includes a processor, and executes, when the processor executes the document processing program, an operation including extracting, through OCR, a plurality of values from a document having a form of electronic data, containing the plurality of values with respect to a specific item, reproducing a same number of the documents as a number of pieces of the values extracted, and assigning a file name including the value, to each of the values, as the file name of each of the documents generated through the reproduction.

In another aspect, the disclosure provides a computer-readable, non-transitory storage medium storing therein a document processing program. The document processing program is configured to cause a computer to execute an operation including extracting, through OCR, a plurality of values from a document having a form of electronic data, containing the plurality of values with respect to a specific item, reproducing a same number of the documents as a number of pieces of the values extracted, and assigning a file name including the value, to each of the values, as the file name of each of the documents generated through the reproduction.

### BRIEF DESCRIPTION OF THE DRAWINGS

FIG. 1 is a block diagram showing a configuration of a document processing system according to an embodiment of the disclosure, including a single computer;

FIG. 2 is a flowchart showing an example of a workflow executed by the system shown in FIG. 1;

FIG. 3 is a sequence chart showing an operation performed by the document processing system shown in FIG. 1, to execute the workflow; and

FIG. 4 is a sequence chart showing an operation performed by the workflow processor shown in FIG. 1, to execute a purchase order processing workflow.

### DETAILED DESCRIPTION

Hereafter, a document processing system and a document processing program according to an embodiment of the disclosure will be described, with reference to the drawings.

First, the configuration of the document processing system according to the embodiment of the disclosure will be described.

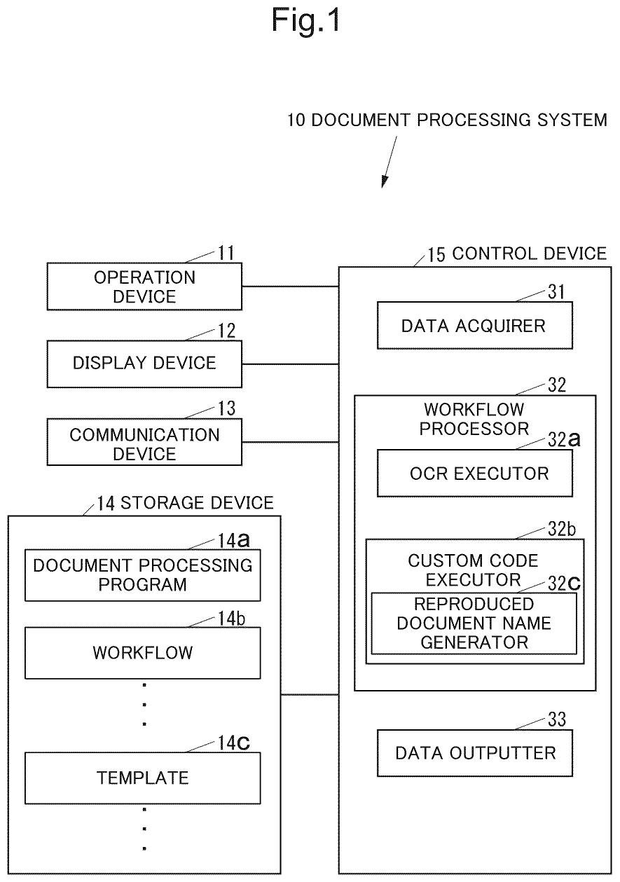

FIG. 1 is a block diagram showing the configuration of the document processing system 10 according to the embodiment, including a single computer.

As shown in FIG. 1, the document processing system 10 includes an operation device 11 having a keyboard, a mouse, and so forth, to which various types of operation are inputted, a display device 12, for example including a liquid crystal display (LCD) for displaying various types of information, a communication device 13 that performs communication with external devices, via a network such as a local area network (LAN) or the internet, or directly through wired or wireless communication, a storage device 14 including non-volatile memory units such as a semiconductor memory and a hard disk drive (HDD), for storing therein various types of information, and a control device 15 that controls the overall operation of the document processing system 10.

The document processing system 10 executes an operation according to a workflow, indicating a process including executing at least one process (hereinafter, “in-workflow process”), when a document in the form of electronic data is inputted in a specific input destination (hereinafter, “document input destination”), and outputting an execution result to a specific output destination (hereinafter, “execution result output destination”).

The storage device 14 contains a document processing program 14a for executing the workflow. The document processing program 14a may be, for example, installed in the document processing system 10 in the manufacturing process thereof, or additionally installed in the document processing system 10 from an external storage medium such as a universal serial bus (USB) memory, or additionally installed in the document processing system 10 from a device on a network.

The storage device 14 also contains a workflow 14b. In the storage device 14, at least one workflow can be stored, in addition to the workflow 14b.

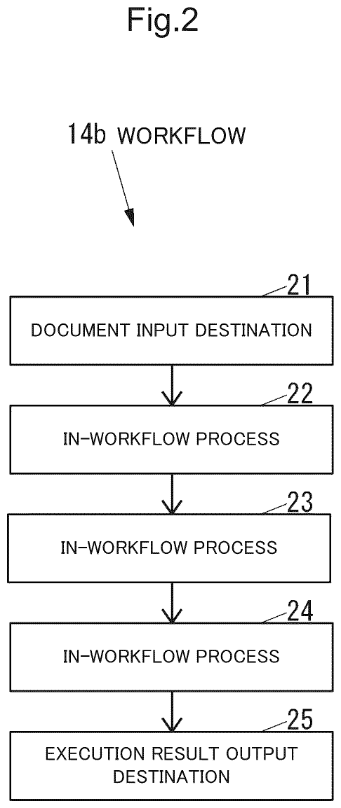

FIG. 2 is a flowchart showing an example of the workflow 14b.

The workflow 14b shown in FIG. 2 includes a document input destination 21 to which a document is inputted, an in-workflow process 22 to be executed first with respect to the document inputted to the document input destination 21, an in-workflow process 23 to be executed with respect to the execution result of the in-workflow process 22, an in-workflow process 24 to be executed with respect to the execution result of the in-workflow process 23, and an execution result output destination 25 to which the execution result of the in-workflow process 24 is outputted.

Examples of the document input destination 21 include a specific output destination, to which an image read by a multifunction peripheral (MFP) configured to read the image of a document, or by an image reading device such as a single-purpose scanner, is outputted, a specific folder in a specific file server, a specific website to which a document can be inputted via a web browser, a specific transmission destination to which a document can be transmitted via e-mail, and a specific transmission destination to which a document can be transmitted from an electronic device such as a PC or a smart device, according to a specific application program other than a web browser or an e-mail client. The workflow 14b is started when a document is inputted to the document input destination 21 specified in the workflow 14b.

Examples of the in-workflow process include:
executing an optical character recognition (OCR) process with respect to an entire range or a specific part thereof of a document;
recognizing a barcode or a 2D code included in the entire range or a specific part thereof of the document;
recognizing whose and of which type the document is, on the basis of the result of OCR executed with respect to the entire range or a specific part thereof of the document;
outputting various types of data acquired from the document, as metadata;
changing the file format of the document;
generating the file name of the document, on the basis of various types of data acquired from the document;
executing an image correction with respect to the document, such as rotating, deskewing, frame deletion, blank page elimination, noise (black spot) deletion, and punch hole deletion; and
sorting the documents, on the basis of at least one of the character, image, barcode, and 2D code extracted from the document.

In the example shown in FIG. 2, three in-workflow processes 22, 23, and 24 are specified in the workflow 14b. Instead, two or fewer in-workflow processes, or four or more in-workflow processes may be specified in the workflow 14b. Although the in-workflow processes are chronologically executed one by one in the example shown in FIG. 2, a plurality of in-workflow processes, to be executed after one in-workflow process is executed, may be prepared, and one of the plurality of in-workflow processes that satisfies a condition may be selected as the in-workflow process to be executed next. Thus, in the workflow 14b, what type of in-workflow process is executed, and in which order the in-workflow process is executed, are specified.

Examples of the execution result output destination 25 include a specific document management system (DMS), a specific enterprise content management (ECM), a specific file server, a specific database, and a specific cloud service. Although only a single execution result output destination is specified in the workflow 14b, in the example shown in FIG. 2, a plurality of execution result output destinations may be specified.

As shown in FIG. 1, the storage device 14 also contains a template 14c. The template 14c includes information for designating a target region of the in-workflow process. For example, the template 14c designates, with respect to a purchase order, an example of the document, a region for executing the OCR process, a region in the purchase order for extracting the purchase order number, and a region in the purchase order for extracting an item code. In the storage device 14, at least one template can be stored, in addition to the template 14c.

The control device 15 includes, for example, a central processing unit (CPU), a read-only memory (ROM) containing programs and various types of data, and a random-access memory (RAM) which is a volatile memory unit to be used as the operating region of the CPU of the control device 15. The CPU of the control device 15 executes the program stored in the storage device 14 or the ROM of the control device 15.

The control device 15 executes the in-workflow processes specified in the workflow, according to the document processing program 14a. In this embodiment, the control device 15 acts, by executing the document processing program 14a, as a data acquirer 31 that acquires the document in the form of electronic data, inputted to the document input destination specified in the workflow, a workflow processor 32 that executes the in-workflow process specified in the workflow, and a data outputter 33 that outputs the data indicating the execution result of the in-workflow process acquired by the workflow processor 32, to a specific execution result output destination.

When acting as the workflow processor 32, the control device 15 acts as an OCR executor 32a that executes the OCR process, and a custom code executor 32b that executes a custom code, representing a function not supported by the basic function of the workflow processor 32. Examples of the custom code include a code for reproducing the document in the form of electronic data, and assigning the file name, to the file of the electronic data generated through the reproduction.

When acting as the custom code executor 32b, the control device 15 reproduces the document in the form of electronic data. The custom code executor 32b acts as a reproduced document name generator 32c, to assign the file name to the electronic data generated through the reproduction.

Hereunder, an operation of the document processing system 10 for executing the workflow will be described.

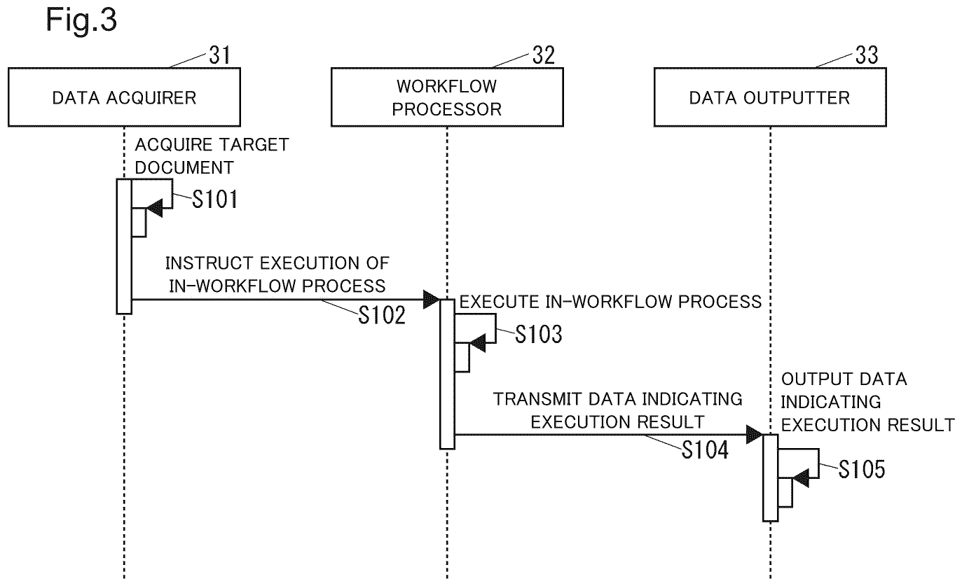

FIG. 3 is a sequence chart showing the operation performed by the document processing system 10, to execute the workflow.

The control device 15 starts the operation, according to the document processing program 14a. The data acquirer 31 identifies the document input destination, specified in a workflow designated in advance as target of reference by the document processing program 14a (hereinafter, “target workflow”), out of the workflows stored in the document processing system 10. The data acquirer 31 makes access to the document input destination identified, for example through the communication device 13. When the document is inputted to the document input destination, the data acquirer 31 acquires the document, which is the target of the in-workflow process (hereinafter, “target document”) (S101).

After S101, the data acquirer 31 instructs the workflow processor 32 to execute the in-workflow process specified in the target workflow (S102).

Upon receipt of the instruction of S102, the workflow processor 32 executes the in-workflow process specified in the target workflow (S103).

After S103, the workflow processor 32 transmits the data indicating the execution result of the operation of S103, to the data outputter 33 (S104).

After S104, the data outputter 33 acquires the data transmitted at S104 from the workflow processor 32, and outputs the data to the specific execution result output destination, indicated by the target workflow (S105).

Hereunder, an example of the target workflow will be described.

The following example refers to the workflow including reproducing the same number of target documents, as the number of item codes included in the target document, in this case the purchase order (document file), and assigning the file name to the document file generated through the reproduction, depending on the purchase order number and the item code included in the purchase order. Such workflow will hereinafter be referred to as “purchase order processing workflow”.

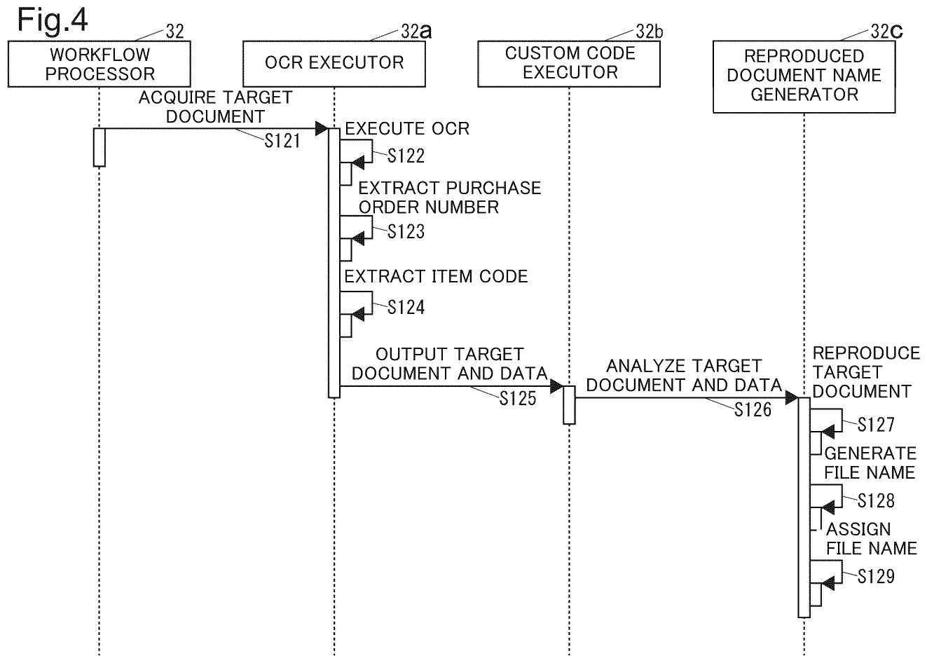

FIG. 4 is a sequence chart showing an operation performed by the workflow processor 32, to execute the purchase order processing workflow as the target workflow.

As shown in FIG. 4, when the workflow processor 32 receives the instruction from the data acquirer 31, the OCR executor 32a acquires the target document from the data acquirer 31 (S121).

The OCR executor 32a executes the OCR process, with respect to the target document acquired as above (S122).

In the case where the purchase order processing workflow specifies the OCR process with respect to the entire region of the target document (i.e., a target region is not designated by the template 14c), the OCR executor 32a executes the OCR process with respect to the entire region of the target document, at S122.

On the other hand, when the purchase order processing workflow specifies the OCR process with respect to a region in the target document, designated in advance by the template 14c, the OCR executor 32a executes the OCR process with respect to such region of the target document, at S122.

The template to be used by the OCR executor 32a is designated by the purchase order processing workflow, out of the templates stored in the storage device 14.

Alternatively, the OCR executor 32a may determine, after executing the OCR process with respect to the entire region of the target document, according to the purchase order processing workflow specifying the OCR process with respect to the entire region of the target document, the template 14c to be used out of the templates stored in the storage device 14, according to the character string recognized through the OCR. In this case, the template 14c determined as above is used for the operation subsequent to S123. For example, in the case where the template 14c is stored in the storage device 14 in association with the identification information of each user, and the OCR executor 32a has detected the identification information of the user from the character string recognized through the OCR of the entire region of the target document, the OCR executor 32a may determine the template 14c associated with the identification information detected, as the template 14c to be used, out of the templates stored in the storage device 14.

After S122, the OCR executor 32a extracts the purchase order number, from the character string recognized through the OCR process of S122 (S123).

When executing the operation of S123, the OCR executor 32a searches the character string recognized through the OCR process of S122, for a character string “purchase order number”, and extracts the character string included in a predetermined range approximate to the character string “purchase order number”, for example the region designated in advance by the template, as the purchase order number, out of the character string recognized through the OCR process of S122. For example, the range designated in advance by the template, with respect to the character string “purchase order number”, includes a range of a specific size, located at a specific position adjacent to the character string “purchase order number” on the right. In the case where the character string “purchase order number” is not found in the character string recognized through the OCR process of S122, the OCR executor 32a extracts a character string included in a region in the target document, designated in advance by the template as the region for the purchase order number, as the purchase order number.

After S123, the OCR executor 32a extracts the item code, from the character string recognized through the OCR process of S122 (S124).

When executing the operation of S124, the OCR executor 32a searches the character string recognized through the OCR process of S122, for a predetermined character string common to the item codes (hereinafter, “character string common to item codes”), and extracts, out of the character string recognized through the OCR process of S122, the character string composed of the character string common to item codes, and a character string included in a predetermined range approximate to the character string common to item codes, for example the region designated in advance by the template, as the item code. For example, the range designated in advance by the template, with respect to the character string common to item codes includes the character string common to item codes, and a character group composed of a prespecified number of letters, following the character string common to item codes. For example, when the character string common to item codes is “ABC00”, the item code may be “ABC0012”, “ABC0013”, and “ABC0014”. In the case where the character string common to item codes is not found in the character string recognized through the OCR process of S122, the OCR executor 32a extracts a character string included in a region in the target document, designated in advance by the template as the region for the item code, as the item code. After S124, the custom code executor 32b acquires the target document, the purchase order number extracted at S123, the item codes extracted at S124, and the number of pieces of the item codes extracted at S124 (hereinafter, “number of pieces of item codes”), from the OCR executor 32a (S125).

In the custom code executor 32b, the reproduced document name generator 32c analyzes the target document, the purchase order number, the item codes and the number of pieces of item codes, transmitted from the OCR executor 32a at S125 (S126).

The reproduced document name generator 32c reproduces the same number of target documents, as the number of pieces of item codes, on the basis of the target document, the purchase order number, the item codes, and the number of pieces of item codes, transmitted from the custom code executor 32b at S126 (S127).

After S127, the reproduced document name generator 32c generates the file name including the purchase order number and one of the item codes, for each of the item codes (S128). For example, when the purchase order number is “XYZ999”, and the item codes are “ABC0012”, “ABC0013”, and “ABC0014”, the reproduced document name generator 32c generates three names, which are “XYZ999ABC0012”, “XYZ999ABC0013”, and “XYZ999ABC0014”, at S128. The file name generated at S128 may also include another character string, provided that the file name includes the purchase order number and one of the item codes. For example, the file name generated at S128 may also include a character string designated by the corresponding template.

After S128, the reproduced document name generator 32c assigns the file names generated at S128, to the respectively corresponding documents generated at S127 (S129). For example, when three file names as “XYZ999ABC0012”, “XYZ999ABC0013”, and “XYZ999ABC0014” are generated at S128, the reproduced document name generator 32c assigns, at S129, the file name “XYZ999ABC0012” to one of the three documents generated at S127, the file name “XYZ999ABC0013” to another of the three documents, and the file name “XYZ999ABC0014” to the remaining one of the three documents.

When the specific execution result output destination is specified in the target workflow, the data outputter 33 outputs, at S105, the document to which the file name has been assigned at S129, to the specific execution result output destination. In addition, the data outputter 33 may determine the specific execution result output destination with respect to each of the documents to which the file name has been assigned at S129, according to the content of the execution result output destination specified in the target workflow. For example, the data outputter 33 may create a folder path of the specific execution result output destination, using at least one of the purchase order number extracted at S123, and the item code extracted at S124. Further, for example, the data outputter 33 may change the execution result output destination with respect to each of the documents to which the file name has been assigned at S129, according to the content of the execution result output destination specified in the target workflow.

As described above, the document processing system 10 extracts, through OCR of the purchase order in the form of electronic data, including a plurality of values with respect to the item code, exemplifying the specific item, the plurality of values of the item code (S124), reproduces the same number of pieces of the purchase order as the number of pieces of the values of the item code extracted (S127), and assigns the file name including the value of the item code with respect to each of the values of the item code, as the file name of the purchase order generated through the reproduction (S128 to S129). Therefore, the same number of pieces of the purchase order, exemplifying the document file (electronic data), including the plurality of values with respect to the item code, as the number of pieces of the item code can be reproduced, and the file names of the purchase order generated through the reproduction can be assigned to the respective values of the item code.

The document processing system 10 creates the folder path of the output destination of the purchase order, to which the file name including the value of the item code is assigned, with respect to each of the values of the item code, using the value thereof. Therefore, the purchase orders generated through the reproduction can be allocated to the folders, according to the value of the item code.

In this embodiment, the document processing system 10 includes the purchase order number and one of the item codes, in the file name of the reproduced document. Instead, the document processing system 10 may exclude the purchase order number from the file name of the reproduced document.

In this embodiment, the item included in the document is exemplified by the item code. However, the disclosure is also applicable to items other than the item code. For example, a commodity name may be used, in place of the item code.

In this embodiment, the document is exemplified by the purchase order. However, the disclosure is also applicable to documents other than the purchase order. For example, the disclosure is also applicable to an invoice, instead of the purchase order.

The document processing system 10 includes a single computer, in this embodiment. However, the document processing system 10 may include a plurality of computers.

The aforementioned existing document processing system is unable to reproduce the same number of documents in the form of electronic data, including a plurality of values with respect to a specific item, as the number of pieces of the value, and assign the file name of the document generated through the reproduction, to each of the values.

In contrast, the document processing system 10 according to the foregoing embodiment can reproduce the same number of documents in the form of electronic data, including a plurality of values with respect to a specific item, as the number of pieces of the value, and assign the file name of the document generated through the reproduction, to each of the values.

While the present disclosure has been described in detail with reference to the embodiments thereof, it would be apparent to those skilled in the art that the various changes and modifications may be made therein within the scope defined by the appended claims.

What is claimed is;:

1. A document processing system comprising:
a storage device contains a document processing program; and
a control device including a processor, and configured to execute, when the processor executes the document processing program, an operation including extracting, through OCR, a plurality of values from a document having a form of electronic data, containing the plurality of values with respect to a specific item, reproducing a same number of the documents as a number of pieces of the values extracted, and assigning a file name including the value, to each of the values, as the file name of each of the documents generated through the reproduction.

2. The document processing system according to claim 1, wherein the control device further acquires the document in the form of electronic data as a processing target, according to a workflow corresponding to the document processing program, out of workflows stored in the storage device, executes the extraction, the reproduction, and the assigning of the file name, and outputs execution results to an output destination indicated by the workflow.

3. The document processing system according to claim 1,
wherein the control device creates a folder path of an output destination of the document, for which the file name including the value has been generated, with respect to each of the values, using the value.

4. A computer-readable, non-transitory storage medium storing therein a document processing program, the document processing program being configured to cause a computer to execute an operation including extracting, through OCR, a plurality of values from a document having a form of electronic data, containing the plurality of values with respect to a specific item, reproducing a same number of the documents as a number of pieces of the values extracted, and assigning a file name including the value, to each of the values, as the file name of each of the documents generated through the reproduction.
